(19) United States
(12) Patent Application Publication
(10) Pub. No.: US 2013/0254082 A1
(43) Pub. Date: Sep. 26, 2013

(54) System and method for automatic invoice approval requests

(71) Applicant: Thomas Zuber, Los Angeles, CA (US)

(72) Inventor: Thomas Zuber, Los Angeles, CA (US)

(21) Appl. No.: 13/849,418

(22) Filed: Mar. 22, 2013

Related U.S. Application Data
(60) Provisional application No. 61/685,747, filed on Mar. 22, 2012.

(51) Int. Cl. G06Q 50/00; G06Q 30/04

(52) U.S. Cl. CPC G06Q 50/01; G06Q 30/04
USPC 705/34

(57) ABSTRACT

A computer-implemented method for circulating invoices electronically to members of a group so that each relevant member of the group can review the invoice and make changes or add comments the other relevant members of the group, in the context of an online network. When the invoice is ready for review by a member of the group, that member receives a notification on his or her online network homepage. The notification that the invoice is ready for review contains a link to the invoice within the online network, so that each reviewing member can automatically access the invoice through the notification link. As each member of the relevant group completes their review of the invoice, a notification is sent to the next member in a sequence of members selected to review the invoice.

### CROSS REFERENCE TO RELATED APPLICATIONS

This application claims the benefit under 35 U.S.C. 119(e) of U.S. Provisional Application Ser. No. 61/685,747 filed Mar. 22, 2012, entitled “System and method for automatic invoice approval requests,” which is incorporated by reference herein in its entirety.

### BACKGROUND OF THE INVENTION

The present invention relates to systems and methods for adding user comments to documents in a financial management tool, or a document management tool, in the context of a secure, online social networking community integrated with a billing tool, and a document management tool, enabled with multiple social networking functionalities, document management functionalities, billing functionalities, and integrative functionalities.

Social networking web sites, such as Facebook.com and MySpace.com, are communities of persons having virtual identities enabled with social networking functionalities. Such sites are often geared towards users having special recreational or social interests such as sports, hobbies or dating. There are also social networking web sites for professionals—for example, Linkedln.com, EsqChat.com and LegallyMinded.com—and some of these sites are communities of persons having virtual identities enabled with social networking functionalities

The prior art discloses software applications for time-keeping and invoicing such as Prolaw® Transactions or AbacusLaw®, and includes all of the features of Prolaw® Transactions or AbacusLaw®, which time-keeping/invoicing tools and features are fully described in the prior art, such disclosures incorporated herein by reference. One of the software applications is an accounting/check-writing tool such as Prolaw® Journals or AbacusLaw®, and includes all of the features of Prolaw® Journals or AbacusLaw®, which accounting/check-writing tools and features are fully described and enabled in the prior art, such disclosures incorporated herein by reference.

The preceding time-keeping and invoicing systems are generally examples of stand-alone systems, most of which are only available as stand-alone systems that require a dedicated network and are not available online. Thus many systems offering time-keeping and invoicing systems are not available with the type of economies of scale obtainable when offered to a larger community online. Some systems provide some functionalities of a document management system in an online context. For instance, Google.com and OpenOffice.org offer applications for creating, editing, deleting, saving and accessing documents in an online context, and for creating, editing, deleting, saving, accessing, sending and receiving emails in an online context. For instance, HyperOffice.com offers an online document organization system for organizing, storing and retrieving documents online. However, such document management systems that operate in an online context are not offered in the context of integration with a networking community made up of virtual identities enabling social networking functionalities, enhanced with the integrative invoicing functionalities described below.

In a business environment, invoices or billing statements must often be reviewed by two or more individuals before being finalized and sent out to the client. There is a hierarchy within most business organizations, and typically the person at the bottom of the organization's hierarchy will need to review the invoice first, and the invoice is then reviewed by persons higher up in the hierarchy, or according to the organization's protocol. Transferring the invoice from one individual to the next can be done in a variety of ways, manually by delivering hard copies from desk to desk, or electronically by fax or email. Each individual will typically make a note or a check mark on the invoice once they have reviewed it, and will then be responsible for sending it on to the next person in the chain to review it and make notes of any changes or corrections. The final person in the series of reviewers must the make sure that the invoice which now contains corrections and changes, is delivered back to the accounts receivable department for finalization. This process requires follow-up by each individual to whom the invoice is circulated, and further follow-up by the accounts receivable department if the invoice is not returned to them after all of the reviewers have reviewed it. This process must be repeated more than once if the invoice is to be re-checked after the first round of changes, and this process must be repeated for each client, every billing cycle.

The process of manually circulating invoices through an organization can be time consuming and inefficient. There is a need for a more efficient means of distributing and circulating invoices for review, correction, and approval by individuals in an organization.

The present invention streamlines the process and eliminates the need for paper or electronic copies to be circulated through among members of the organization.

### SUMMARY OF THE INVENTION

The present invention describes an integration of cloud computing-based services through a portal that combines social networking functionalities with financial management tools (such as are described in U.S. patent application Ser. No. 12/575,442 incorporated by reference herein), and billing, accounting and invoicing tools, further enhanced with integrative functionalities as described herein.

As a function of the network's financial management tool, the present invention will enable an organization within the social network to create a list of members of the network who are required to review draft client invoices. This list of members and the sequence of members who will review an invoice can be customized for each client. When a draft invoice is ready for review, an automatic notification will be sent to the first member to review the draft invoice. The notification of the invoice approval request will appear on the profile home page of the first member. When the first member clicks on the invoice approval request, the draft invoice will open on his screen, and he will then be able to review the invoice. After he has reviewed it, and made any comments or corrections, he will click “Approve Draft Invoice,” and an invoice approval request will then automatically appear on the profile home page of the second member in the reviewer sequence. When the second member clicks on the invoice approval request, the draft invoice will open on his screen, and he will then be able to review the draft invoice with the first member's comments and corrections. After the final member of the reviewer sequence has reviewed the invoice and clicked on “Approve Draft Invoice,” a final version of the invoice may be issued.

### BRIEF DESCRIPTION OF THE DRAWINGS

FIG. 1 is a representation of a member's home page screen on a graphical user interface from which a member may view and access Invoice Approval notifications.

FIG. 2 is a representation of a graphical user interface for the invoice managing tool accessible through the secure social network.

FIG. 3 is a representation of a graphical user interface for the invoice reviewer designation page within the invoice managing tool.

FIG. 4 is a representation of a graphical user interface for the invoice reviewer sequencing page within the invoice managing tool.

FIG. 5 is a representation of a billing entry created within the financial management tool.

### DETAILED DESCRIPTION OF THE INVENTION

In the following description of the present invention, reference is made to the accompanying drawings which form a part thereof, and in which is shown by way of illustration, exemplary embodiments illustrating the principles of the present invention and how it may be used. It is to be understood that other embodiments may be utilized to practice the present invention and structural and functional changes may be made thereto without departing from the scope of the present invention.

In a system described in U.S. patent application Ser. Nos. 12/575,442 and 12/493,096, both incorporated by reference herein in their entirety, a secure social networking community is described, where the members of the social networking community are professionals such as lawyers, accountants, doctors, bankers, teachers, artists, or any other type of person that provides services to others.

It should be noted that the term “profile” or “member profile” includes a member's public pages or information visible to the public generally, as well as information that is visible only to the member himself, as well as information visible only to other members specified by the member, and information visible as specified by the member, and information that may not be visible to other members.

The term “member's home page” or “home page” is defined as the primary screen which appears when a member logs into the secure social network.

The term “access a document” is defined as the ability to view, edit, delete, file, or otherwise manage the document. In the context of the present invention, “access” also includes the ability to import and export information to and from the document management, financial management, and calling tools associated with the matter or document. Additionally, it allows a member to add information to the document.

The term “matter” is defined as it is commonly understood in the legal industry, a specific job being worked on for a client such as a lawsuit or a business deal, for example a litigation matter, or a transactional matter.

The term “associated with” is defined broadly to mean connected to in such a way that members who work on a matter are identified in the system as being associated with it, and may be designated as an invoice reviewer for that matter. Additionally, an invoice is associated with a matter if it pertains to that matter, i.e. the invoice relates to work done in connection with the matter. In the preferred embodiment, the invoice makes direct reference to its associated matter or some other matter identifier, such as a matter ID number. In some examples, any member associated with a matter will appear on the billing invoice. In some examples, invoices may be indexed based on the matter, matter identifier, or members associated with that invoice such that invoices are searchable by their associated matter, matter identifier, and/or members.

An “invoice reviewer” is defined as a member who is associated with an invoice and who has been designated to receive a notification of a request to review the invoice pertaining to or associated with the matter. In some examples, this notification appears on the home page of the member.

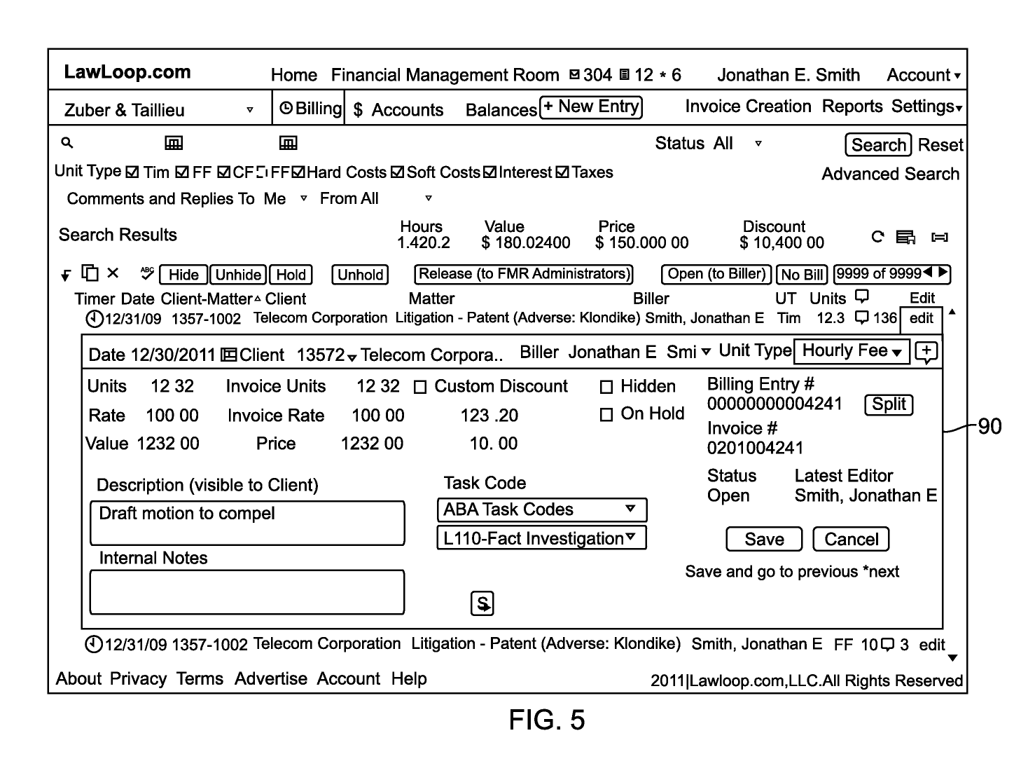

A billing tool is used in the invention described herein. The billing tool is generally known in the art, and is used to create, delete, edit, store, track, record, and otherwise manage billing entries for the member's clients. An example of a billing entry is shown at 90 in FIG. 5.

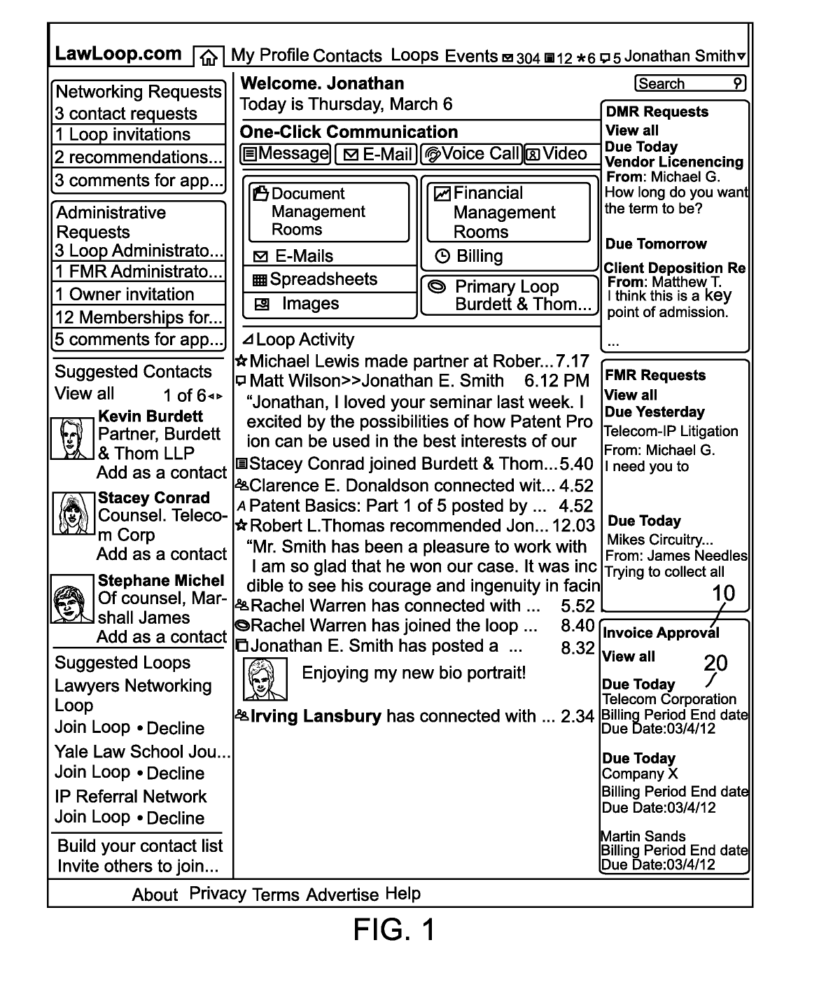

In the embodiments above, members also have access to a financial management tool which is integrated with the social networking functionalities, document management functionalities and integrative functionalities described above. A further integrative functionality allows members of a network to use the financial management tool to remotely and collectively manage time-keeping/invoicing records and data and accounting/check-writing records and data. The financial management tool comprises software applications allowing members to remotely and collectively manage time-keeping/invoicing records and data and accounting/check-writing records and data. One of the software applications is a time-keeping/invoicing tool such as Prolaw® Transactions or AbacusLaw®, and includes all of the features of Prolaw® Transactions or AbacusLaw®, which time-keeping/invoicing tools and features are fully described in the prior art, such disclosures incorporated herein by reference. One of the software applications is an accounting/check-writing tool such as Prolaw® Journals or AbacusLaw®, and includes all of the features of Prolaw® Journals or AbacusLaw®, which accounting/check-writing tools and features are fully described and enabled in the prior art, such disclosures incorporated herein by reference. The member owning the profile depicted at FIG. 6 described above may access the financial management tool by clicking on a “Time-Keeping/Invoicing” icon on his/her home page like the “Emails” icon on the home page depicted at FIG. 1, or clicking on an “Accounting/Check-Writing” icon on his/her home page like the “Word Processing” icon on the home page depicted at FIG. 1.

The present invention discloses a secure, network-based collaborative work environment in which one or more members of an online community having virtual identities is enabled with a plurality of social networking functionalities, document management functionalities, and billing, accounting and invoicing functionalities.

The billing, accounting and invoicing functionalities are used within this network-based collaborative environment to record billable hours worked, costs incurred, and to create invoices for each client showing the billing rates, hours worked, and costs incurred.

This network-based collaborative environment contains sub-group organizations of members within the larger online community. Each sub-group organization is a secure network for members of wherein members of the network share access to invoices in a secure remote environment, wherein members not belonging to the sub-group organization do not have access to the invoices.

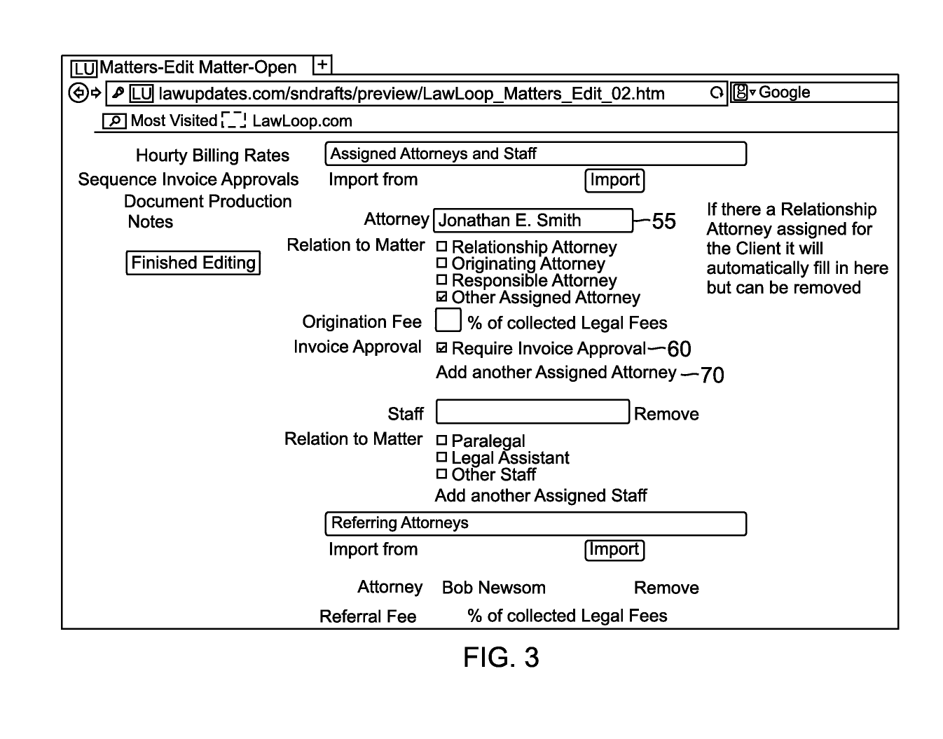

This collaborative environment contains a matter managing tool, through which members of the organization are associated with matters, each matter typically relating to one or more clients. One or more members may be designated as an invoice reviewer associated with each matter. More particularly, the matter managing tool has a page which allows a user to designate members as invoice reviewers associated with a specific matter (FIG. 3). In the preferred embodiment, these designations are made by a network administrator. The administrator will select a member from a smart field or a drop down menu containing a list of members (as shown at 55 in FIG. 3). To designate a member as an invoice reviewer, the administrator selects from members who are working on or involved with a matter, and designates selected members as invoice reviewers, by checking a box labeled “Invoice Approval” (as shown at 60 in FIG. 3). The administrator may designate more than one member as an invoice reviewer by adding additional members (as shown at 70 in FIG. 3). It is understood that the foregoing details may be varied without altering the scope of the invention. For example, a member of the network other than a network administrator may associate members of the network with a matter as invoice reviewers.

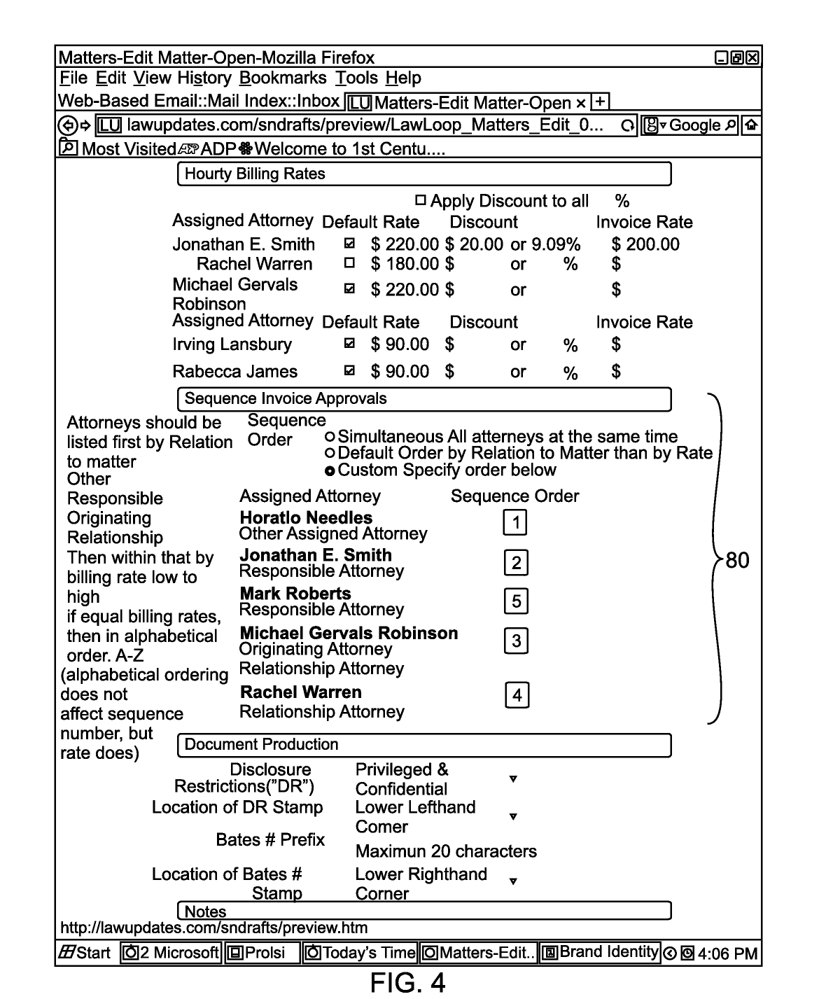

The administrator then selects the sequence order of the invoice reviewers. This is done on another screen after the invoice reviewers have been designated for a matter (as shown at 80 in FIG. 4. The administrator sequences the invoice reviewers by inserting numbering in boxes on the screen, designating each reviewer with a position in the sequence (as shown at 80 in FIG. 4).

The collaborative environment also contains an invoice managing tool, through which members of the organization are associated with invoices, each invoice typically relating to one or more clients. One or more members may be designated as an invoice reviewer associated with each invoice. More particularly, the invoice managing tool has a page which allows a user to designate members as invoice reviewers. In the preferred embodiment, these designations are made by an administrator of the organization. The administrator will select a member from a smart field containing a list of members. To designate a member as an invoice reviewer, the administrator selects from members who are working on or involved with a matter, and designates selected members as invoice reviewers, by checking a box labeled “Invoice Approval.” The administrator may designate more than one member as an invoice reviewer by adding additional members.

The invoice managing tool functions such that when a draft invoice has been prepared for any matter, each of the invoice reviewers associated with that particular matter will receive a notification of a request to review an invoice associated with the matter. Notifications are received on the home page of said each invoice reviewer's profile. The invoice managing tool links each notification to the invoice file, such that notifications include a link to the invoice, and when the invoice reviewer clicks on the notification, the draft invoice appears on his screen and he is able to review it. Each invoice created in the invoice managing tool has associated with it a sequenced list of invoice reviewers. The invoice reviewers are listed in a preset sequence. The sequence of invoice reviewers is such that an invoice reviewer placed earlier in the sequence receives notification of the invoice to be reviewed before invoice reviewers placed later in the sequence. The sequence of invoice reviewers is set by the administrator of the organization.

When the draft invoice is created and ready for review, a notification is sent to the first reviewer in the sequence. The draft invoice must first be reviewed by the first invoice reviewer in the sequence of invoice reviewers. Once the first reviewer has reviewed the invoice and added any comments or corrections, if necessary, the reviewer then clicks on an onscreen to indicate that he has completed his review of the invoice. This onscreen button may have the words “Approve Draft Invoice” on it, in the preferred embodiment. Clicking of this button triggers a notification to be automatically sent/presented to the next invoice reviewer in the sequence. The next invoice reviewer then receives a notification on the home page of said reviewer's profile. When this invoice reviewer clicks on the notification, the draft invoice appears on his screen and he/she is able to review it. Each invoice reviewer in the sequence does not receive such notification until the invoice has been reviewed by the invoice reviewer, or reviewers, placed earlier in the sequence. Each reviewer after reviewing the invoice must click on the “Approve Draft Invoice” button, which indicates that they have completed their review, and simultaneously triggers a notification to be automatically sent to the next invoice reviewer in the sequence. At least one invoice reviewer in the sequence of reviewers for a particular invoice must review the invoice and click on “Approve Draft Invoice” to allow the invoice to be issued in final draft form.

As a default function of the invoice review requirement, at least one invoice reviewer in the sequence of reviewers for a particular invoice may have to review the invoice and click on “Approve Draft Invoice” to allow the invoice to be issued in final draft form. However, the invoice management tool may provide an override function which allows a member of the network other than the first invoice reviewer review the invoice and approve the invoice so that the invoice can be issued.

The invoice managing tool may also be set to require just one invoice reviewer for a matter. If set for just one invoice reviewer, rather than a sequence of reviewers, then once the one reviewer reviews the invoice and clicks on “Approve Draft Invoice” the system allows the invoice to be issued in final draft form.

The invoice managing tool includes a commenting tool that enables a first invoice reviewer in the sequence of reviewers to associate a comment with an invoice, such that the comment remains associated with the invoice. The comment can be addressed to a second invoice reviewer of the invoice reviewers and the second invoice reviewer receives a notification of the comment on the page of the second invoice reviewer's profile. The comment can be viewed by later invoice reviewer, or the comment can be made private such that members of the network other than the designated recipient do not have access to the comment.

In addition to the invoice managing tool, this collaborative environment also contains a financial management tool for managing financial documents. This financial management tool is comprised of at least one of the following software applications: an accounting application, and/or a billing application. This financial management tool enables members of the network to remotely manage financial documents within this secure collaborative environment.

In addition to the invoice managing tool, and the financial management tool, this collaborative environment also contains a document management tool for managing documents. This document management tool is comprised of at least one of the following software applications: a message application, an email application, word processor application, a spreadsheet application, a presentations application, and an images application. This document management tool enables members of the network to remotely manage documents within this secure collaborative environment.

FIG. 1 shows a representation of a member's home page screen on a graphical user interface from which a member may view and access Invoice Approval notifications. An area of the member's home page is designated for Invoice Approval notifications (as shown at 10 in FIG. 1). Each notification includes the name of the party to whom the invoice is being sent, the billing period end date, and the invoice approval due date (as shown at 20 in FIG. 1).

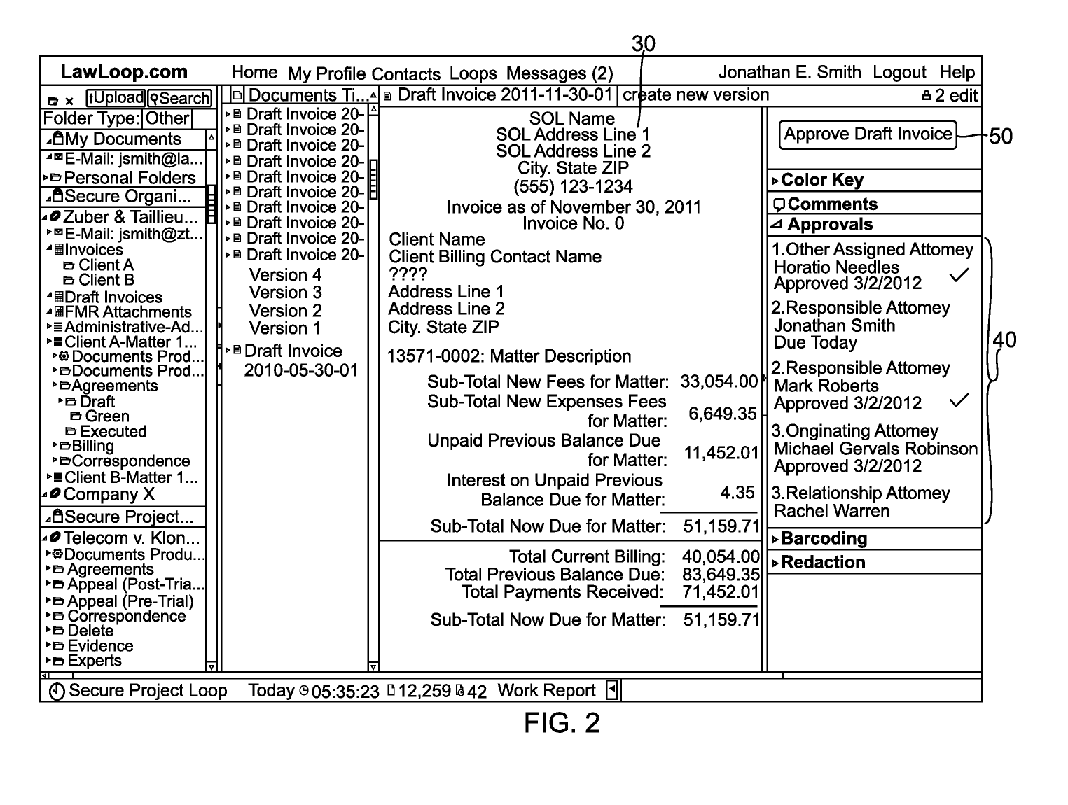

When a draft invoice has been prepared for any matter, each of the invoice reviewers associated with that particular matter will receive a notification of a request to review the invoice associated with the matter. Notifications are received on the home page of said each invoice reviewer's profile. The invoice managing tool links each notification to the invoice file, such that notifications include a link to the invoice, and when the invoice reviewer clicks on the notification (as shown at 20 in FIG. 1), the draft invoice appears on his screen and he is able to review it (as shown at 30 in FIG. 2). Each invoice created in the invoice managing tool has associated with it a sequenced list of invoice reviewers. The invoice reviewers are listed in a preset or preselected sequence (as shown at 40 in FIG. 2). The sequence of invoice reviewers is such that an invoice reviewer placed earlier in the sequence receives notification of the invoice to be reviewed before invoice reviewers placed later in the sequence. The sequence of invoice reviewers is set by the administrator of the organization.

When the draft invoice is created and ready for review, a notification is sent to the first reviewer in the sequence. The draft invoice must first be reviewed by the first invoice reviewer in the sequence of invoice reviewers. Once the first reviewer has reviewed the invoice and added any comments or corrections, if necessary, the reviewer then clicks on an onscreen button to indicate that he has completed his review of the invoice. This onscreen button may have the words “Approve Draft Invoice” on it, in the preferred embodiment (as shown at 50 in FIG. 2). Clicking this button triggers a notification to be automatically sent to the next invoice review in the sequence. The next invoice reviewer then receives a notification on the home page of said reviewer's profile. When this invoice reviewer clicks on the notification, the draft invoice appears on his screen and he is able to review it. Each invoice reviewer in the sequence does not receive such notification until the invoice has been reviewed by the invoice reviewer, or reviewers, placed earlier in the sequence. Each reviewer after reviewing the invoice must click on the “Approve Draft Invoice” button, which indicates that they have completed their review, and simultaneously triggers a notification to be automatically sent to the next invoice reviewer in the sequence. At least one invoice reviewer in the sequence of reviewers for a particular invoice must review the invoice and click on “Approve Draft Invoice” to allow the invoice to be issued in final draft form.

It should be understood throughout this specification that an invoice reviewer may approve or deny an invoice. Approvals and denials may be in-whole or in-part. Systems according to the invention may be configured and/or programmable to provide that approvals or denials may only be in-whole or that they may also be in-part, e.g., on a line item basis.

Various aspects of and tools utilized in embodiments of the instant invention may be adapted from commonly-owned U.S. Provisional Application Ser. No. 61/210,627, filed Mar. 20, 2009, U.S. application Ser. No. 12/493,096, filed Jun. 26, 2009, U.S. application Ser. No. 12/575,442, filed Oct. 7, 2009, U.S. application Ser. No. 12/885,325, filed Sep. 17, 2010, U.S. application Ser. No. 13/011,655, filed Jan. 21, 2011, U.S. application Ser. No. 13/023,461, filed Feb. 8, 2011, U.S. application Ser. No. 13/247,813, filed Sep. 28, 2011, U.S. application Ser. No. 13/278,127, filed Oct. 20, 2011, U.S. application Ser. No. 13/324,980, filed Dec. 13, 2011, U.S. application Ser. No. 13/645,234, filed Oct. 4, 2012, and U.S. Provisional Application Ser. No. 61/688,335, filed May 10, 2012, each of which is incorporated by reference herein in its entirety.

It is to be understood that other embodiments may be utilized and functional changes may be made without departing from the spirit and scope of the present invention. The foregoing descriptions of the embodiments of the invention have been presented for the purposes of illustration and description. It is not intended to be exhaustive or to limit the invention to the precise forms disclosed. Accordingly, many modifications and variations are possible in light of the above teachings.

What is claimed is:

1. A computerized system for interactively collaborating within an online community, comprising:
a plurality of members, each of the members owning a profile;
a network of members that excludes at least one member of the community, wherein members of the network share access to invoices in a secure remote environment, wherein members not belonging to the network do not have access to the invoices; and
a matters tool for associating members of the network with a matter as invoice reviewers, wherein each of the invoice reviewers receives a notification of a request to review an invoice associated with the matter on a page of said each invoice reviewer's profile, wherein the invoice reviewers are placed in a sequence, wherein an invoice reviewer placed earlier in the sequence receives such notification before invoice reviewers placed later in the sequence.

2. The system of claim 1, wherein an invoice reviewer of the invoice reviewers does not receive such notification until the invoice reviewers placed earlier in the sequence review the invoice.

3. The system of claim 1, wherein a first invoice reviewer of the invoice reviewers does not receive such notification until a second invoice reviewer of the invoice reviewers placed earlier in the sequence reviews the invoice; and wherein review by the second invoice reviewer causes the notification to the first invoice reviewer.

4. The system of claim 1, wherein a first invoice reviewer of the invoice reviewers does not receive such notification until a second invoice reviewer of the invoice reviewers placed earlier in the sequence reviews the invoice, and wherein at least one of the first invoice reviewer and the second invoice reviewer must review the invoice for the invoice to be issued.

5. The system of claim 1, wherein a first invoice reviewer of the invoice reviewers does not receive such notification until a second invoice reviewer of the invoice reviewers placed earlier in the sequence reviews the invoice; wherein review by the second invoice reviewer causes the notification to the first invoice reviewer, and wherein at least one of the first invoice reviewer and the second invoice reviewer must review the invoice for the invoice to be issued.

6. The system of claim 1, wherein the notification includes a link to the invoice.

7. The system of claim 1, further comprising an invoice managing tool for managing the invoice, wherein the notification includes a link to the invoice, and wherein a list of invoice reviewers associated with the invoice is attached to the invoice.

8. The system of claim 1, also comprising a commenting tool that enables a first invoice reviewer of the invoice reviewers to associate a comment with the invoice, wherein the comment can be addressed to a second invoice reviewer of the invoice reviewers and the second invoice reviewer receives a notification of the comment on the page of the second invoice reviewer's profile, and wherein the comment can be made private such that at least one member of the network does not have access to the comment.

9. The system of claim 1, wherein the invoice is not issued until a first invoice reviewer of the invoice reviewers reviews the invoice, or a member of the network other than the first invoice reviewer overrides a requirement that the first invoice reviewer reviews the invoice for the invoice to be issued.

10. A computerized system for interactively collaborating within an online community, comprising:
a plurality of members, each of the members owning a profile;
a network of members that excludes at least one member of the community, wherein members of the network share access to invoices in a secure remote environment, wherein members not belonging to the network do not have access to the invoices; and
an invoice reviewer associating tool for associating members of the network with an invoice as invoice reviewers, wherein each of the invoice reviewers receives a notification of a request to review the invoice on a page of said each invoice reviewer's profile, wherein the invoice reviewers are placed in a sequence, wherein an invoice reviewer placed earlier in the sequence receives such notification before invoice reviewers placed later in the sequence.

11. The system of claim 10, wherein an invoice reviewer of the invoice reviewers does not receive such notification until the invoice reviewers placed earlier in the sequence review the invoice.

12. The system of claim 10, wherein a first invoice reviewer of the invoice reviewers does not receive such notification until a second invoice reviewer of the invoice reviewers placed earlier in the sequence reviews the invoice; and wherein review by the second invoice reviewer causes the notification to the first invoice reviewer.

13. The system of claim 10, wherein a first invoice reviewer of the invoice reviewers does not receive such notification until a second invoice reviewer of the invoice reviewers placed earlier in the sequence reviews the invoice, and wherein at least one of the first invoice reviewer and the second invoice reviewer must review the invoice for the invoice to be issued.

14. The system of claim 10, wherein a first invoice reviewer of the invoice reviewers does not receive such notification until a second invoice reviewer of the invoice reviewers placed earlier in the sequence reviews the invoice; wherein review by the second invoice reviewer causes the notification to the first invoice reviewer, and wherein at least one of the first invoice reviewer and the second invoice reviewer must review the invoice for the invoice to be issued.

15. A computerized system for interactively collaborating within an online community, comprising:
a plurality of members, each of the members owning a profile;
a network of members that excludes at least one member of the community, wherein members of the network share access to invoices in a secure remote environment, wherein members not belonging to the network do not have access to the invoices; and
a matters tool for associating a member of the network with a matter as an invoice reviewer, wherein the invoice reviewer receives a notification of a request to review an invoice associated with the matter on a page of the invoice reviewer's profile.

16. A computerized system for interactively collaborating within an online social networking community, comprising:
a plurality of members, each of the members owning a profile, which profile is enabled with a plurality of social networking functionalities;
a network of members that excludes at least one member of the community, wherein members of the network share access to invoices in a secure remote environment, wherein members not belonging to the network do not have access to the invoices; and
an invoice reviewer associating tool for associating a member of the network with an invoice as an invoice reviewer, wherein the invoice reviewer receives a notification of a request to review the invoice on a page of the invoice reviewer's profile.

17. The system of claim 16, wherein the invoice reviewer must review the invoice for the invoice to be issued.

18. The system of claim 16, further comprising an invoice managing tool for managing the invoice, wherein the notification includes a link to the invoice.

19. The system of claim 16, also comprising a commenting tool that enables the invoice reviewer to associate a comment with the invoice, wherein the comment can be addressed to a second member of the network and the second member receives a notification of the comment on a page of the second member's profile, and wherein the comment can be made private such that at least one member of the network does not have access to the comment.

20. The system of claim 16, wherein the invoice is not issued until an invoice reviewer reviews the invoice, or a member of the network other than the invoice reviewer overrides a requirement that the invoice reviewer reviews the invoice for the invoice to be issued.

21. A computer-implemented method for interactively collaborating within an online social networking community, comprising the steps of:
associating a first and second member of said online social networking community with a matter, said matter being associated with an invoice, said online social networking community comprising a plurality of members, each of the members owning a profile, which profile is enabled with a plurality of social networking functionalities, wherein said first and second members are part of a network of members, said network excluding at least one other member of the social networking community, wherein members of the network share access to invoices in a secure remote environment, wherein members not belonging to the network do not have access to the invoices;
assigning, using a matters tool, said first and second members as invoice reviewers for said invoice;
placing said first member first in a sequence of invoice reviewers and said second member second in said sequence of invoice reviewers;
sending a first notification to said first member associated with said invoice, said first notification appearing on a page associated with said first member's profile;
receiving, from said first member, a second notification associated with said invoice, said second notification indicating whether said invoice was reviewed by said first member;
sending a third notification to said second member associated with said invoice, said invoice having been reviewed by said first member, said third notification appearing on a page associated with said second member's profile; and
receiving, from said second member, a fourth notification associated with said invoice, said fourth notification indicating whether said invoice was reviewed by said second member.
